(19) United States
(12) Patent Application Publication
(10) Pub. No.: US 2016/0379440 A1
(43) Pub. Date: Dec. 29, 2016

(54) METHOD FOR ACCESS CONTROL USING A MOBILE DEVICE

(71) Applicant: GMSG Holding AB, Sater (SE)

(72) Inventor: Robert Jakobsson, Sater (SE)

(73) Assignee: GMSG Holding AB, Sater (SE)

(21) Appl. No.: 14/750,254

(22) Filed: Jun. 25, 2015

(51) Int. Cl. G07F 17/32; G06F 3/048

(52) U.S. Cl. CPC G07F 17/3237; G07F 17/3272; G06F 3/048; G07F 17/323

(57) ABSTRACT

A method for controlling betting in multiplayer computer games. The method comprises the steps of enabling a plurality of client applications to connect to a server system, wherein identification information identifying a player is received from each connecting client application, enabling the players to chose a multiplayer computer game, performing player selection for the multiplayer computer game, for selection of at least two players who wants to play the same multiplayer computer game, determining an amount of currency to be bet, securing, from each player account of the selected players the amount of currency that is to be bet, starting, in a separate virtual server, the multiplayer computer game with the selected players, monitoring the multiplayer computer game during the performance of the multiplayer computer game in the separate virtual server, and dividing the secured currency according to predetermined rules taking into account the performance of the players during the game.

### BACKGROUND OF THE INVENTION

1. Field of the Invention

The present invention relates to a method for controlling betting in multiplayer computer games. The present invention also relates to a server and a computer program for performing the method.

2. Description of the Related Art

Multiplayer computer games have become very popular during the last decade. This is partly due to the continuing development and expansion of broadband internet infrastructure which provides increasingly fast internet access to players, and partly due to the rapid development of the computer games which has provided the players with an increasingly realistic feeling which in turn has increased the interest of players to play the games. With the increasing number of people playing multiplayer games over the internet has followed a large interest in betting. Betting in multiplayer internet games have so far been limited to traditional betting games such as internet poker. In order to implement betting also in other multiplayer internet games such games have to be altered to provide the necessary security for the money transactions involved.

### SUMMARY OF THE INVENTION

The object of the present invention is to provide a method for controlling betting in existing multiplayer internet games.

Another object of the present invention is to provide a server and a computer program for controlling betting in existing multiplayer internet games.

At least one of these objects is achieved with a method, a server and a computer program according to the independent claims.

Further advantages are provided with the features in the dependent claims.

According to a first aspect of the present invention a method is provided for controlling betting in multiplayer computer games. The method comprises the step of enabling a plurality of client applications to connect to a server system, wherein identification information identifying a player is received from each connecting client application. The method further comprises the steps of enabling the players to chose a multiplayer computer game, performing player selection for the multiplayer computer game, for selection of at least two players who want to play the same multiplayer computer game, determining an amount of currency to be bet, securing, from each player account of the selected players, the amount of currency that is to be bet, starting, in a separate virtual server, the multiplayer computer game with the selected players, monitoring the multiplayer computer game during the performance of the multiplayer computer game in the separate virtual server, and dividing, after the multiplayer computer game has ended, the secured currency according to predetermined rules taking into account the performance of the players during the game.

The division of the secured currency may be performed in many different ways. The administrator of the server system preferably takes some of the currency while the winner or winner gets the rest.

With a method according to the invention the betting is controlled in a secure way. The method may be used together with existing games without implementing betting capabilities in the games. Each one of the client applications have already connected to a game handling application which has verified which games the client applications are licensed to play. The game handling application may be any game handling application such as the application known as Steam.

The step of enabling the player to choose a game may comprise the steps of retrieving from the game handling application information on which games that are available to a player, sending such information on available games to the player. The player may then send a signal on the choice of game to the server. The games are initiated by an initiating player requesting the initiation of a game. The initiating player chooses whether he wants to challenge specific players or if he desires to be matched with suitable players by the server system.

The player selection may comprise the steps of receiving from a player a request to challenge at least one specific player, starting a virtual game room for the game, sending a notification to the challenged player and enabling the player to enter the virtual game room, and receiving an accept message from the challenged player when he has accepted the challenge and entered the virtual game room. It is also possible for a player to challenge a specific team in a corresponding way.

If the player initiating a game does not want to specify specific players it is possible to initiate a game with a specific bet. For such a game the player selection may comprise the steps of receiving from a player a request to initiate a game, wherein the request comprise an amount of currency to be bet and a desired number of players in the game, receiving a plurality of requests from players to join an initiated game, wherein the request comprise the amount of currency to be bet, selecting the desired number of players who wants to bet the same amount of currency, and adding the selected players to the game.

These two main alternatives of initiating a game also indicate the alternatives for the opponents to the initiating player. The opponents may accept a challenge, define a desired bet and let the server system match him against other players or choose between different initiated games with set bets.

The method may comprise the step of requesting from a database, for each requesting player, a player attribute which indicates earlier cumulative performance for the player, and wherein the player selection is performed so that players having corresponding attributes are selected to play a multiplayer computer game. This enables the matching of players having corresponding skill and experience in a game.

The player attribute may comprise a player game attribute for each game which indicates earlier cumulative performance for the player for that game. Thus, a player may be matched against skilled players for one game and unskilled players in another game.

The player game attribute may comprise at least one of a rate indicating earlier success in the game, karma indicating the judgement of earlier opponents of the player, team points indicating earlier team members judgement of the player, and activity level indicating earlier activity of the player. It is of course possible to include also other factors in the player game attribute.

The step of monitoring the multiplayer computer game may comprise registering of keystrokes made by the players, and recording video sequences of the multiplayer computer game. This makes it possible for the administrator of the server system to watch a played game. In this way it is easier to detect any cheating in the game.

The method may comprise the steps of storing the registered keystrokes and storing the recorded video sequences in a database, wherein the stored information is available to players. This makes it possible for the players of the server system to watch a played game. In this way it is easier to detect any cheating in the game and makes it possible for the players to file a complaint.

The step of securing the amount of currency that is to be bet may comprise moving said amount of currency from the player account of each one of the players to a stand account controlled by the server system. This makes it more difficult to cheat as the currency is not available to the players when the game has started.

The step of dividing the secured currency may be performed only after reception of an approval signal from each player by the server system. This enables the addition of an approval from each player after a game has been played. Thus, each participating player has to approve the game before the server system divides the currency. If any one of the players wants to file a complaint the player does not send any approval signal.

According to a second aspect of the invention a server system is provided which is arranged to perform the method according to the first aspect of the invention.

According to a third embodiment of the invention a computer program is provided for controlling betting in multiplayer computer games, which when run on a computer system cause the computer system to perform the method according to the first aspect of the invention.

According to a fourth aspect of the invention a computer program product is provided on which is stored in a non-volatile memory a computer program according to the third aspect of the invention.

In the following preferred embodiments of the invention will be described with reference to the appended drawings.

### BRIEF DESCRIPTION OF THE DRAWINGS

FIG. 1 shows a server system in which the method according to an embodiment of the invention is performed.

FIG. 2 shows schematically a flow chart over a method according to an embodiment of the invention.

### DESCRIPTION OF PREFERRED EMBODIMENTS OF THE INVENTION

In the following description of preferred embodiments of the invention, the same reference numeral will be used for the same feature in the different drawings.

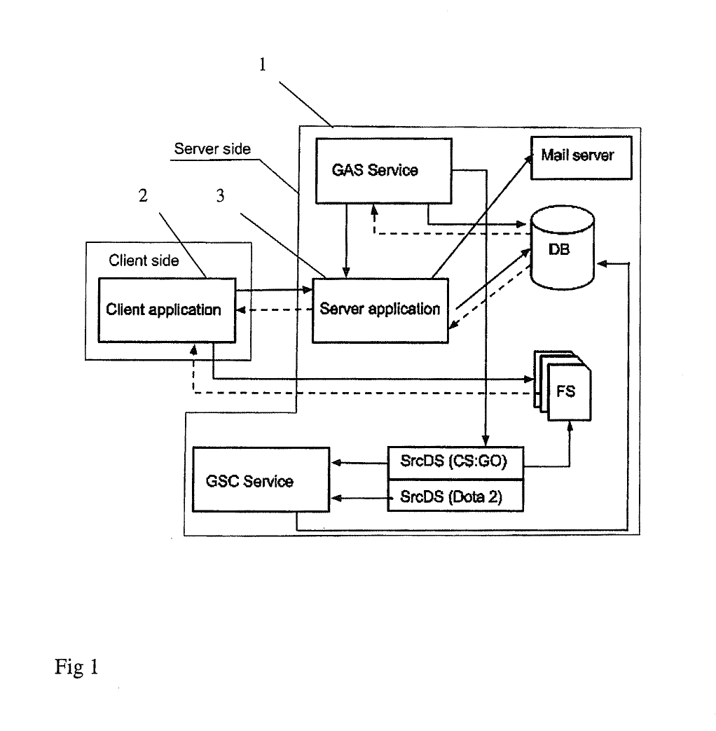

FIG. 1 shows schematically the interaction between different applications when a method according to an embodiment of the invention is performed. The method is performed by a computer program which controls a server system 1. A client application 2 is connected to the server system 1. The server system 1 comprises a first server 3 on which a server application is executed. The server application is central to the method and is connected to the Internet. The first server 1 can by a virtual server or a physical server. The server application is in contact with a database DB which in the shown embodiment is run on a separate server. The database DB contains information on players such as a player attribute which indicates earlier cumulative performance for the player. The player attribute may comprise a player game attribute for each game which indicates earlier cumulative performance for the player for that game. The player game attribute comprises at least one of a rate indicating earlier success in the game, karma indicating earlier opponent's judgement of the player, team points indicating earlier team members judgement of the player, and activity level indicating earlier activity of the player. The database DB may also contain other data associated with a player such as the amount of currency available to a player and possible presettings for the player. The server application registers data in and retrieves data from the database DB, provides a logic game room, i.e., a virtual server for each ongoing multiplayer computer game, manages financial operations and work with payment systems. The server application also ensures the safety of the whole system and the logic of protection and punishment, implements communication with players, chat and obscene words/spam filters. Further, the server application implements an interface for system administration, manages the notification service and manages the bonus system.

Each client runs a client application on his own desktop computer. Only one client application is shown in FIG. 1, but it is of course possible to arrange a large number of client applications connected to the server application. The client application is an interface for working with the server application. The main purpose of the client application is to provide a convenient and safe way to work with the system. The client application makes it possible to register and/or login to the system, to make the necessary set of application settings, to upload and view content from the Server application, and to send requests to the server application. The client application may have a lot of different functions. For example it is possible that the client application allows the player to search for specific players.

The system comprises a game auto search service GAS Service, which is arranged to find suitable opponents to a player sending a request to the server application to start playing a multiplayer computer game. The GAS Service monitors and creates virtual game servers SrcDS, removes of offline players of the virtual game servers SrcDS after a specified time, and closes inactive virtual servers SrcDS after a specified time. The GAS Service starts the game on the virtual servers SrcDS. The abbreviations in parenthesis refer to the different games that are run on the virtual servers. CS:GO refers to Counter Strike:GO.

The virtual game servers SrcDS are responsible for gaming processes. The virtual game servers SrcDS are connected to a GSC service and to a file server FS. The virtual game servers transmit data regarding game details to the GSC service. The GSC service stores the data, transmitted from the virtual game servers SrcDS, in the database DB. The virtual game servers SrcDS also transmit recordings of the multiplayer games to the file server FS. The GSC Service is responsible for the collection and transmission of gaming events for the collection and analysis of unique statistics.

The system also comprises a mail server for sending mails between players or between the system managers and the players.

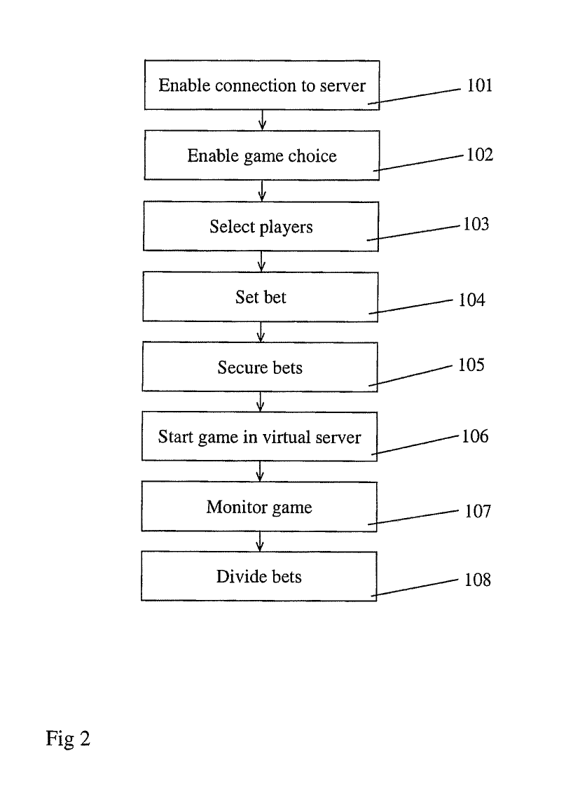

The method for controlling betting in multiplayer computer games will now be described with reference to FIG. 2. In a first step 101, a plurality of client applications connect to the server 2, and client identification information identifying a player is received from each connecting client application. Each one of the client applications have already connected to a game handling application which has verified which games the client applications are licensed to play. The game handling application may be any game handling application such as the application known as Steam. In step 102, the server enables the players to choose a multiplayer computer game among the games which they are licensed to play. In step 103, player selection for the multiplayer computer game is performed, for selection of at least two players who wants to play the same multiplayer computer game. It is possible for the player to select whether he wants to play with specific players as opponents or if he wants the system to select the opponents. The number of players to be selected is at least two players. The number of players in a specific multiplayer computer game may be predetermined or may be set by request from a requesting player. The selection will be described in more detail below. In step 104, the amount of currency that is to be bet determined and, in step 105, the amount of currency that is to be bet is secured by the server application for each selected player. Each player has in advance transmitted an amount of currency to the system. When the amount of currency to be bet has been secured the player no longer has access to that amount of currency. In step 106, the GAS Service starts, in a separate virtual server SrcDS, the multiplayer computer game with the selected players. In step 107, the Gas Service monitors the multiplayer computer game during the performance of the multiplayer computer game in the separate virtual server, and controls the GSC Service to send data regarding the game to the database DB and to send videos to the file server FS. Finally, in step 108, after the multiplayer computer game has ended the secured currency is divided between the selected players and the administrator according to predetermined rules taking into account their performance during the game.

The attributes of the players are preferably updated after each game taking into account the performance of each player in the played game. Thus, a victory increases the rate of the player while a defeat decreases the rate of the player. The player selection may comprise the step of selecting the predetermined number or players among the requesting players who wants to play the same multiplayer game and who wants to bet the same amount of currency. The selection may also be based on the earlier cumulative performance of the players. To this end server application may retrieve from the database DB the player game attribute for the requesting players. The player game attribute may comprise at least one of a rate indicating earlier success in the game, karma indicating earlier opponents' judgement of the player, team points indicating earlier team members judgement of the player, and activity level indicating earlier activity of the player. The players are selected so that they have corresponding earlier cumulative performance.

The monitoring of the multiplayer computer game comprises registering of keystrokes made by the players, and recording video sequences of the multiplayer computer game.

The monitoring of the multiplayer computer game may comprise the steps of storing the registered keystrokes and storing the recorded video sequences in a database available to players.

As mentioned above the client applications have to connect/log in on a game handling application such as a Steam account before connecting to the server 2. In this application the game handling application will be called Steam account. The Steam account is an application which handles game purchases and allows a player with an account to purchase games and to log in and play purchased games.

A player who has connected/logged in on his Steam account and chosen a game to play has different options. The player may chose to start a new game in a number of different ways.

The player may choose between team game and player game. The player may also choose if he wants to initiate a new game or if he wants to join an already initiated game. In the first case he may choose if he wants to challenge specific players or if he wants to challenge players using matching. In the first case the server 2 receives from a player a request to challenge at least one specific player. The specific player(s) may be chosen, e.g., from a list of friends defined earlier by the player or from a list of all available players. After having received the request the server 2 starts a virtual game room for the game and sends a notification to the challenged player(s). After having received an accept message from the (all) challenged player(s) that they have entered the virtual game room, the game is started as described above. If the player instead chooses to initiate a team game he may choose to initiate a team game with predefined teams or with random players. In the first case the server 2 receives the request and sends a notification to all members of the teams. When all members of the teams have accepted the server starts the game as described above.

If the player does not want to challenge specific players he may instead choose to initiate a game with specific settings. The settings may include the amount of currency to be bet to enter the game, the number of players in game or the teams, victory condition.

Players who do not want to initiate a game may instead join an initiated game. The player may join an initiated game in a number of different ways. The player may choose an initiated game from a list in which the settings for the game are displayed. If he chooses to enter a game with teams he may choose any team with a free spot. Alternatively the player may choose to enter the game by choosing matching. The player then chooses desired settings for the game, such as the amount of currency to be bet. Possibly the player chooses also other settings, such as number of players in the game. When the server 2 receives the request from the player the server 2 sends a request to the GAS Service to find a game with matching opponents. The GAS Service has access to players who have sent requests to join the game, wherein the requests comprise the amount of currency to be bet. The server selects the desired number of players who wants to bet the same amount of currency, and add the selected players to the game.

The selection of players may preferably comprise the step of requesting from a database, for each requesting player, a player attribute which indicates earlier cumulative performance for the player, and wherein the player selection is performed so that players having corresponding player attributes are selected to play a multiplayer computer game. Thus, the players selected to an initiated game are selected so that their player attribute matches the player attribute of the player initiating the game. The player attribute may comprise a player game attribute for each game which indicates earlier cumulative performance for the player for that game. The player game attribute may comprise a rate indicating earlier success in the game, karma indicating earlier opponents' judgement of the player, team points indicating earlier team members judgement of the player, and activity level indicating earlier activity of the player.

Apart from the above described alternatives a player may also have the option to join a game as spectator. Games can be private and will then not appear in any list to join as a spectator. Such private games may be accessible only by invitation from a player of the game through the notification system.

Before joining a game or challenging another player a player may view statistics of completed games, and performed results of other players.

It is possible for players to create different lists of players such as lists of friends. The addition of a friend may be arranged to require an affirmation of the friends to be added. The player may also create blacklists comprising a list of players from which the player does not want to receive any messages, not want to receive any chat messages and/or not want to receive any challenges or game invitations.

The step 107 of monitoring the multiplayer computer game preferably comprises registering of keystrokes made by the players, and recording video sequences of the multiplayer computer game. The registered keystrokes are stored in a database and the recorded video sequences in a database. The stored information is preferably available to players as has been mentioned above. Preferably the recorded video sequences are stored in a separate database called a file server.

The server system is arranged for safe money transactions. Each player has a player account comprising currency with which the player may bet in the games. However, the server system does not allow currency to be removed or added directly from or to a player account. Instead when a player wants to fill more currency to the player account of the player money is credited to the administrator account. The amount of money transferred to the administrator account is transformed into an amount of currency which is then transferred to the player account. Inversely, when a player wants to withdraw money the player has to send a request to the administrator. When the server system receives the request to withdraw money is transferred from the player account of the player to the administrator account. Upon confirmation of the withdrawal by the administrator, the money is debited from the account administrator and sent to the player. During game play all bets are taken from the player accounts of the players.

Some of the key aspects of the system are that:

Currencies do not appear out of nowhere and do not disappear;
Initially all monetary units are in the administrator account;
The administrator cannot play or bet stakes;
Every operation with currencies is recorded in a transaction table with a detailed description and a reference to players who are participating in the operation;

All currency in the system corresponds to real money coming from payment gateways and added by the users to their player accounts. Thus, money cannot be added to or removed from the system without a real transaction which is logged and checked.

When a player enters the game room, the server system secures currency in the player account of the player and moves the currency to a separate stand account accessible only to the administrator. At the end of a game the server system withdraws a percentage of the amount of currency in the stand wallet and transfers it to the administrator account. The server system then distributes the remaining amount of currency between the winners of the game.

During each operation with a player account, the server system recalculates the sum of all customer transactions and compares with the sum of contents in player accounts. If the sums do not match the player is blocked until the matter has been clarified by the administrator.

The server system preferably has a secure database in which all transactions are duplicated. The server system preferably compares the sums in the primary database and the secure database. If the sums do not match the player is blocked until the matter has been clarified by the administrator.

In this application the term server is used for the computer/computers on which the data from the mobile device is checked and from which the access grant is sent. The server may be a number of different computers. A server service is located at a publically available IP on the internet. The service comprising a computer program according to the present invention is built on several co-operating parts; business logic, algorithms for biometric analysis, an access database and a function to send authorized access to the third party.

What is claimed is:

1. A method for controlling betting in multiplayer computer games, comprising the steps of:
enabling a plurality of client applications to connect to a server system, wherein identification information identifying a player is received from each connecting client application,
enabling the players to chose a multiplayer computer game,
performing player selection for the multiplayer computer game, for selection of at least two players who wants to play the same multiplayer computer game,
determining an amount of currency to be bet,
securing, from each player account of the selected players the amount of currency that is to be bet,
starting, in a separate virtual server, the multiplayer computer game with the selected players,
monitoring the multiplayer computer game during the performance of the multiplayer computer game in the separate virtual server, and
dividing, after the multiplayer computer game has ended, the secured currency according to predetermined rules taking into account the performance of the players during the game.

2. The method according to claim 1, wherein the player selection comprises the steps of:
receiving from a player a request to challenge at least one specific player,
starting a virtual game room for the game,
sending a notification to the challenged player and enabling the player to enter the virtual game room, and
receiving an accept message from the challenged player when he has accepted the challenge and entered the virtual game room.

3. The method according to claim 1, wherein the player selection comprises the steps of:
receiving from a player a request to initiate a game, wherein the request comprise an amount of currency to be bet and a desired number of players in the game,
receiving requests from a plurality of requesting players to join an initiated game, wherein each request comprises the amount of currency to be bet,
selecting among the plurality of requesting players the desired number of players who wants to bet the same amount of currency, and
adding the selected players to the game.

4. The method according to claim 3, wherein the method comprises the step of requesting from a database, for each requesting player, a player attribute which indicates earlier cumulative performance for the player, and wherein the player selection is performed so that players having corresponding attributes are selected to play a multiplayer computer game.

5. The method according to claim 4, wherein the player attribute comprises a player game attribute for each game which indicates earlier cumulative performance for the player for that game.

6. The method according to claim 5, wherein the player game attribute comprises at least one of a rate indicating earlier success in the game, karma indicating earlier opponents judgement of the player, team points indicating earlier team members judgement of the player, and activity level indicating earlier activity of the player.

7. The method according to claim 1, wherein the step of monitoring of the multiplayer computer game comprises registering of keystrokes made by the players, and recording video sequences of the multiplayer computer game.

8. The method according to claim 6, comprising the steps of storing the registered keystrokes and storing the recorded video sequences in a database, wherein the stored information is available to players.

9. The method according to claim 1, wherein the step of securing the amount of currency that is to be bet comprises moving said amount of currency from the player account of each one of the players to a stand account controlled by the server system.

10. The method according to claim 9, wherein the dividing the secured currency is performed only after reception of an approval signal from each player by the server system.

11. A server system arranged to perform the method according to claim 1.

12. A computer program for controlling betting in multiplayer computer games, which when run on a computer system causes the computer system to perform the method according to claim 1.

13. Computer program product on which is stored in a non-volatile memory a computer program according to claim 12.
